(19) United States
(12) Patent Application Publication
(10) Pub. No.: US 2014/0108948 A1
(43) Pub. Date: Apr. 17, 2014

(54) INTEGRATED COMMUNICATION SYSTEM AND METHOD THEREOF

(71) Applicant: YOMORE TECHNOLOGY CO., LTD., Kaohsiung City (TW)

(72) Inventors: Jao-Ching Lin, KAOHSIUNG CITY (TW); Wen-Ting Lee, KAOHSIUNG CITY (TW); Chun-Kai Ni, KAOHSIUNG CITY (TW)

(73) Assignee: YOMORE TECHNOLOGY CO., LTD., Kaohsiung City (TW)

(21) Appl. No.: 14/054,847

(22) Filed: Oct. 16, 2013

(30) Foreign Application Priority Data
Oct. 16, 2012 (TW) 101138065

(51) Int. Cl. G06F 3/048

(52) U.S. Cl. CPC G06F 3/048
USPC 715/740

(57) ABSTRACT

An integrated communication system includes a communication integration device, and a user terminal. The communication integration device includes at least two communication bridging units and a communication integration module, wherein each of the communication bridging units is configured to link to an external communication system, the communication integration module can selectively activate one of the communication bridging units, and thereby integrate and link to the external communication systems linked with the communication bridging units. The user terminal includes a user interface and an internal communication unit, wherein the user interface can generate a control command according to a user operation for controlling the communication integration module to select to activate one of the communication bridging units, the internal communication unit can link to the communication integration device for performing external communication through the external communication system linked with the activated communication bridging unit.

### BACKGROUND OF THE INVENTION

1. Field of the Invention

The present invention relates to an integrated communication system, and more particularly, to an integrated communication system capable of integrating external communication systems.

2. Description of the Prior Art

As related technology keeps improving, many kinds of communication devices are gradually developed, such that a user can use different kinds of communication devices to perform communication operations in different communication modes. For example, the user can use a home communication system for making a call through a landline, or the user can use a mobile phone for making a call through a mobile communication network.

As Internet communication becomes more popular, Internet phones are developed for transmitting voice packages through Internet, so as to make a voice or video call. More particularly, such as Skype, MSN, and Yahoo messenger. Moreover, when a mobile phone is capable of accessing the Internet, the user can use the mobile phone to make an Internet call through the Internet.

The above communication modes all have advantages and disadvantages. For example, when making a call through the landline or the mobile communication network, the communication quality is good and stable, but the user will be charged for communication fee. Although the Internet call is free, but the communication quality is not stable when the Internet call is made at some place with bad Internet reception or insufficient bandwidth.

However, when staying home, since the Internet quality is generally good enough, the user can communicate with other people by the way of Internet communication for saving money, but the user may still have incoming calls of other communication modes . Such that the user needs to make a choice between the communication modes. Due to habit, most of the people may choose the conventional landline phone system and mobile phone with good and stable communication quality, such that the communication charge can not be effectively reduced by using the Internet phone. Moreover, the user may suffer some bad influences from the conventional communication modes, such as influence of electromagnetic waves from mobile phones.

Therefore, it is an important topic to develop an integrated communication device for solving the above problems.

### SUMMARY OF THE INVENTION

The present invention provides an integrated communication system comprising a communication integration device, and a user terminal. The communication integration device comprises at least two communication bridging units and a communication integration module, wherein each of the communication bridging units is configured to link to an external communication system, the communication integration module can selectively activate one of the communication bridging units, and thereby integrate and link to the external communication systems linked with the communication bridging units. The user terminal comprises a user interface and an internal communication unit, wherein the user interface can generate a control command according to a user operation for controlling the communication integration module to select to activate one of the communication bridging units, the internal communication unit can link to the communication integration device for performing external communication through the external communication system linked with the activated communication bridging unit.

The present invention further provides a method for integrating communication. The method comprises providing an integrated communication system comprising a communication integration device and a user terminal, the communication integration device comprising at least two communication bridging units, each of the communication bridging units being configured to link to an external communication system, the user terminal being configured to link to the communication integration device; receiving a user input command through the user terminal, and generating a control command according to the user input command; the communication integration device selectively activating one of the communication bridging units according to the control command; and the user terminal performing an external communication operation through the external communication system linked with the activated communication bridging unit.

In contrast to the prior art, the integrated communication system of the present invention can collect data of the external communication systems, then directly select to integrate with one of the external communication systems through operations of the user terminal, and further perform an external communication operation through the selected external communication system. In other words, the integrated communication system of the present invention can link to every kind of external communication system for integrating data and communication function of the external communication system. The user only needs to operate the user terminal to obtain data of the external communication system for further selecting an external communication mode. For example, performing an external communication operation through a public switched telephone network (PSTN), Ethernet, Wi-Fi or mobile communication system. In addition, the integrated communication system of the present invention can automatically select an optimum communication device and communication mode for performing communication operations according to predetermined priority of communication conditions, in order to reduce communication charge or improve communication quality. Therefore, the integrated communication system of the present invention can increase convenience and improve communication efficiency.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an integrated communication system of the present invention.

FIG. 2 is a diagram showing the integrated communication system of the present invention communicating with external communication systems.

FIG. 3 is a diagram showing another embodiment of the integrated communication system of the present invention.

FIG. 4 is a diagram showing the integrated communication system of the present invention controlling home appliances.

FIG. 5 is a flowchart showing the method for integrating communication of the present invention.

### DETAILED DESCRIPTION

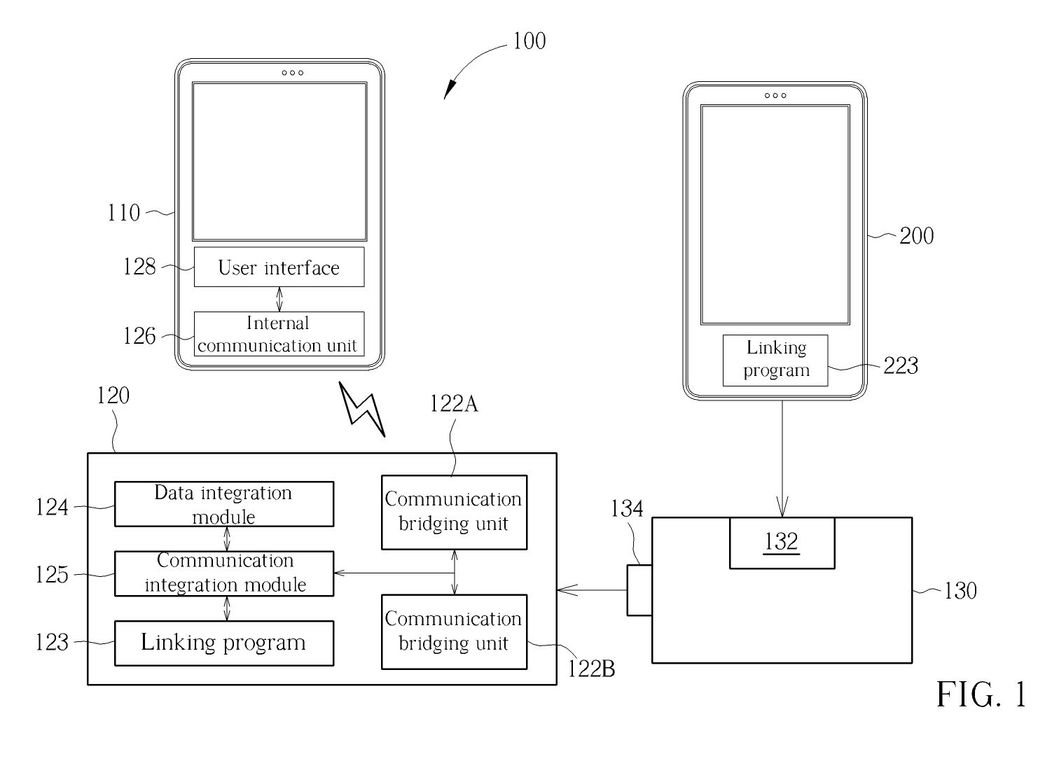

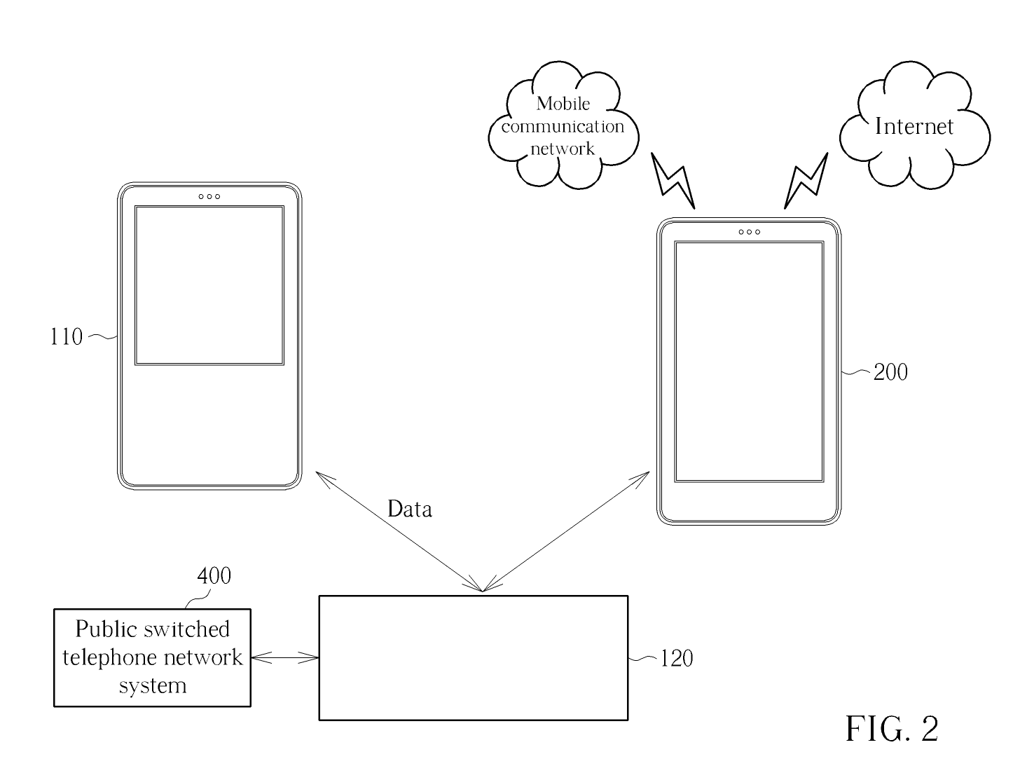

Please refer to FIG. 1 and FIG. 2 together. FIG. 1 is a diagram showing an integrated communication system 100 of the present invention. FIG. 2 is a diagram showing the integrated communication system 100 of the present invention communicating with external communication systems. In the present embodiment, the external communication systems comprise a public switched telephone network (PSTN) system 400 and a mobile phone 200. In fact, the external communication system can comprise a public switched telephone network (PSTN), Ethernet, Wi-Fi or mobile communication system.

As shown in figures, the integrated communication system 100 of the present invention comprises a user terminal 110 and a communication integration device 120, and may optionally comprise a sub station 130. In a preferred embodiment, the user terminal 110 is configured to link to the communication integration device 120 wirelessly. The user terminal 110 comprises a display for displaying data, and a user interface for generating a control command according to a user operation. In a preferred embodiment, the display is a touch display utilized as the user interface. For example, a user can input a user input command on the touch display (such as inputting a touch gesture), and the user terminal 110 can further generate a control command corresponding to the user input command. The communication integration device 120 is linked to the user terminal 110 by any wireless communication technique (such as digital enhanced cordless telecommunication (DECT), Zigbee, infrared, Bluetooth, Wi-Fi or radio communication techniques) for data connection. Moreover, the communication integration device 120 can allow the user terminal 110 plugging in. When the user terminal 110 is plugged into the communication integration device 120, the communication integration device 120 can charge the user terminal 110. The sub station 130 can connect to and activate at least one external communication system, and also link to the user terminal by any wireless communication technique (such as Bluetooth, Wi-Fi or radio communication techniques) for data connection. In addition, the sub station 130 comprises an external device connection port 132 for coupling and linking with a mobile phone 200, and activating a mobile communication system of the mobile phone 200; and a sub internal communication unit 134 for coupling and linking to the communication integration device 120. The sub internal communication unit 134 can communicate with the communication integration device 120 via an internal transmission technique. The internal transmission technique comprises digital enhanced cordless telecommunication, Wi-Fi, Bluetooth, Zigbee, infrared, universal serial bus (USB) or Ethernet, but is not limited by the above. When the mobile phone 200 is coupled to a mobile phone slot 132 of the sub station 130, a communication bridging unit 122A can link to the mobile phone 200 through the sub station 130.

Wherein, the above communication integration device 120 comprises at least two communication bridging units 122A and 122B, a data integration module 124, and a communication integration module 125. The communication integration device 120 can further comprise a linking program 123. When the communication bridging unit 122A is linked with the mobile phone 200, the linking program 123 can communicate with a corresponding linking program 223 of the mobile phone 200, such that the data integration module 124 can receive data of the mobile phone 200 via the communication bridging unit 122A, the data of the mobile phone 200 comprises phone book data, social network data (such as Facebook account data), Internet communication data (such as Skype account data or MSN account data) and/or short message data. The data received by the data integration module 124 can be further transmitted to the user terminal 110 through the communication integration device 120 or the sub station 130, and displayed on the display of the user terminal 110. The communication bridging unit 122B is linked to a public switched telephone network system 400 for allowing the user making a landline call. The communication integration module 125 can selectively activate one of the communication bridging units 122A and 122B according to the control command generated by the user terminal 110, in order to link the user terminal 110 to the external communication system for transmitting communication data mutually.

For example, when the user terminal 110 receives the data stored or captured by the mobile phone 200 (such as phone book data, social network data, Internet communication data and/or short message data), the user can browse the data by using the user terminal 110, then the user can select a phone number on the user terminal 110 according to the phone book data, and further determine to make a call through the public switched telephone network system 400 or the mobile phone 200. The user terminal 110 then generates a corresponding control command.

Wherein, if the user determines to make a call through the public switched telephone network system 400, the communication integration module 125 can link the user terminal 110 to the public switched telephone network system 400 via the communication bridging unit 122B according to the control command generated by the user terminal 110, in order to make a call through the public switched telephone network system 400.

If the user determines to make a call through the mobile phone 200, the communication integration module 125 can link the user terminal 110 to the mobile phone 200 via the communication bridging unit 122A according to the control command generated by the user terminal 110, in order to make a call via a mobile phone network. When the user terminal 110 make a call through the mobile phone 200, audio or video data received by the mobile phone 200 is transmitted to the user terminal 110 through the communication integration device 120 or the sub station 130. In addition, the user can also input short message on the user terminal 110, and transmit the short message by using the mobile phone 200 via the communication integration device 120.

Or, when the mobile phone 200 is capable of accessing Internet, the user can select a user account on the user terminal 110 according to the social network data or the Internet communication data, and determine to make an Internet call or transmit an Internet message (or perform other types of Internet communication) by the mobile phone 200. Then the user terminal 110 generates a corresponding control command. The communication integration module 125 can link the user terminal 110 to the mobile phone 200 according to the control command generated by the user terminal 110 for making an Internet call or transmitting an Internet message (or performing other types of Internet communication) via Internet. If the public switched telephone network system 400 also has Internet access function, the user can determine to perform Internet communication through the public switched telephone network system 400 or the mobile phone 200 on the user terminal 110.

On the other hand, the communication integration device 120 can further comprise more communication bridging units in order to link to more external communication systems simultaneously, such that the user terminal 110 can collect data from a plurality of external communication systems, and select to integrate with one of the external communication systems for performing communication operations.

In addition, the communication integration module 125 can link the user terminal 110 to the external communication system according to the control command generated by the user terminal 110 and/or a predetermined priority of communication conditions for performing communication operations. For example, when the user sets to communicate by a way with lowest communication rate, the communication integration module 125 determines to make a call in a way with the lowest communication rate according to communication rates of the landline, mobile communication network or mobile Internet. When the mobile phone 200 can access Internet for free, the communication integration module 125 can link the user terminal 110 to the mobile phone 200 for making free Internet calls through Internet. Similarly, the communication integration module 125 can also select an optimum communication device to perform communication operations according to conditions of reception strength or Internet speed, in order to improve communication quality. Especially when the communication integration module 125 is linked with a plurality of external communication systems simultaneously, the communication integration module 125 can determine the optimum communication device and optimum communication mode to perform communication operations according to conditions of communication rate, reception strength and/or Internet speed.

According to the above arrangement, when the user comes home and plugs the mobile phone 200 into the external device connection port 132 of the sub station 130, the integrated communication system 100 of the present invention can transmit the data of the mobile phone 200 to the user terminal 110. The user only needs to use the user terminal 110 to make a call or perform other communication operations through the public switched telephone network system 400 or the mobile phone 200. Similarly, when the mobile phone 200 has an incoming call, the mobile phone 200 can transmit data of the incoming call to the user terminal 110 through the communication integration device 120, and the user can directly use the user terminal 110 to answer the incoming call of the mobile phone 200.

In the above embodiment, the mobile phone 200 is not necessary to link to the communication bridging unit 122A through the sub station 130. The mobile phone 200 can link to the communication bridging unit 122A wired or wirelessly (such as by Bluetooth) . Moreover, the linking program 123, the data integration module 124 and/or the communication integration module 125 are not limited to be installed on the communication integration device 120. The linking program 123, the data integration module 124 and/or the communication integration module 125 can also be installed on the user terminal 110.

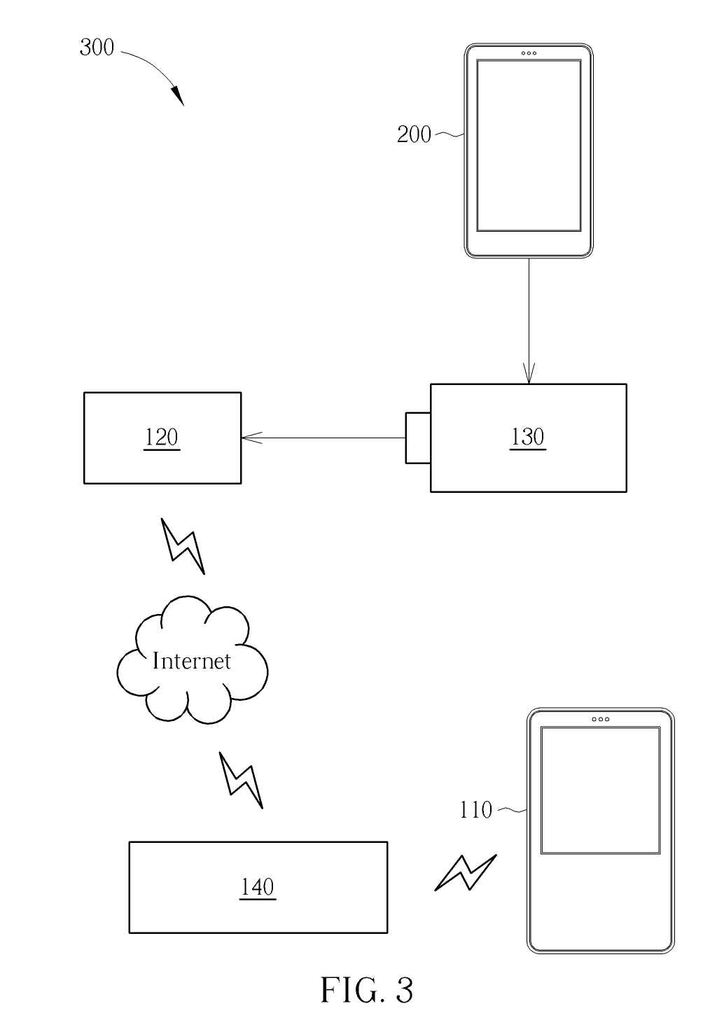

Please refer to FIG. 3. FIG. 3 is a diagram showing another embodiment of the integrated communication system 300 of the present invention. As shown in FIG. 3, the integrated communication system 300 of the present invention can further comprise an extension sub station 140 for linking to the communication integration device 120 through one of the above internal transmission techniques, such that when the user terminal 110 is far away from the communication integration device 120, the user terminal 110 can link to the communication integration device 120 through the extension sub station 140 for performing communication operations.

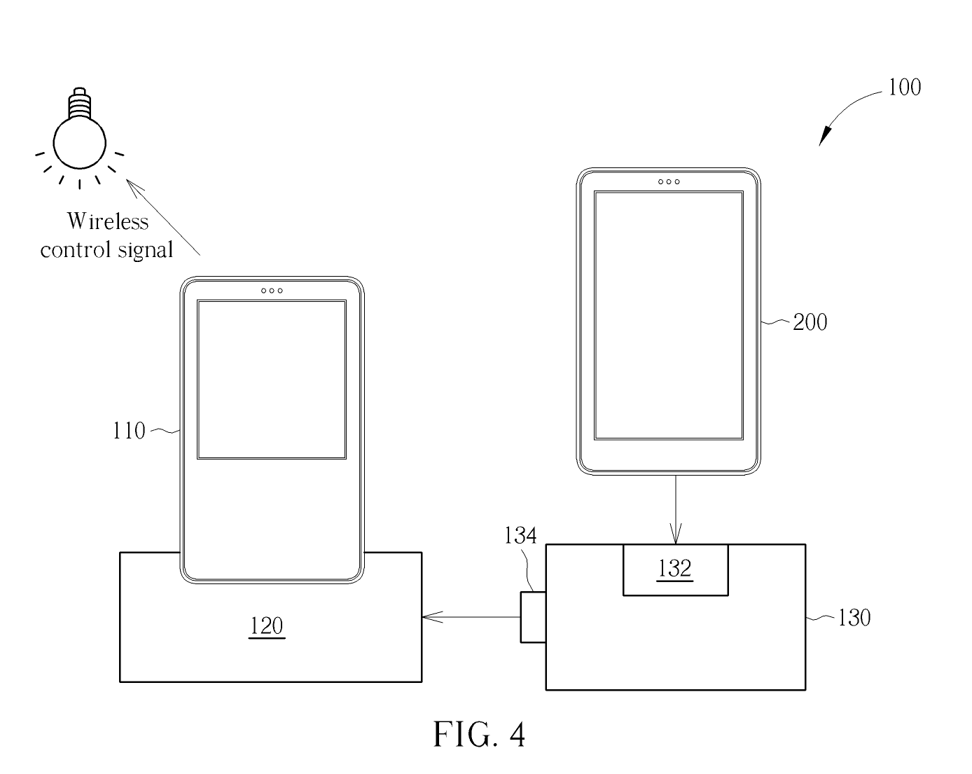

Please refer to FIG. 4. The integrated communication system 100 of the present invention can further facilitate controlling home appliances. As shown in FIG. 4, when the user comes home and plugs the mobile phone 200 into the external device connection port of the sub station 130 (that is linking the integrated communication system 100 with the mobile phone 200), the integrated communication system 100 can transmit a wireless control signal to control the home appliances, such as turning on lights or an air conditioner.

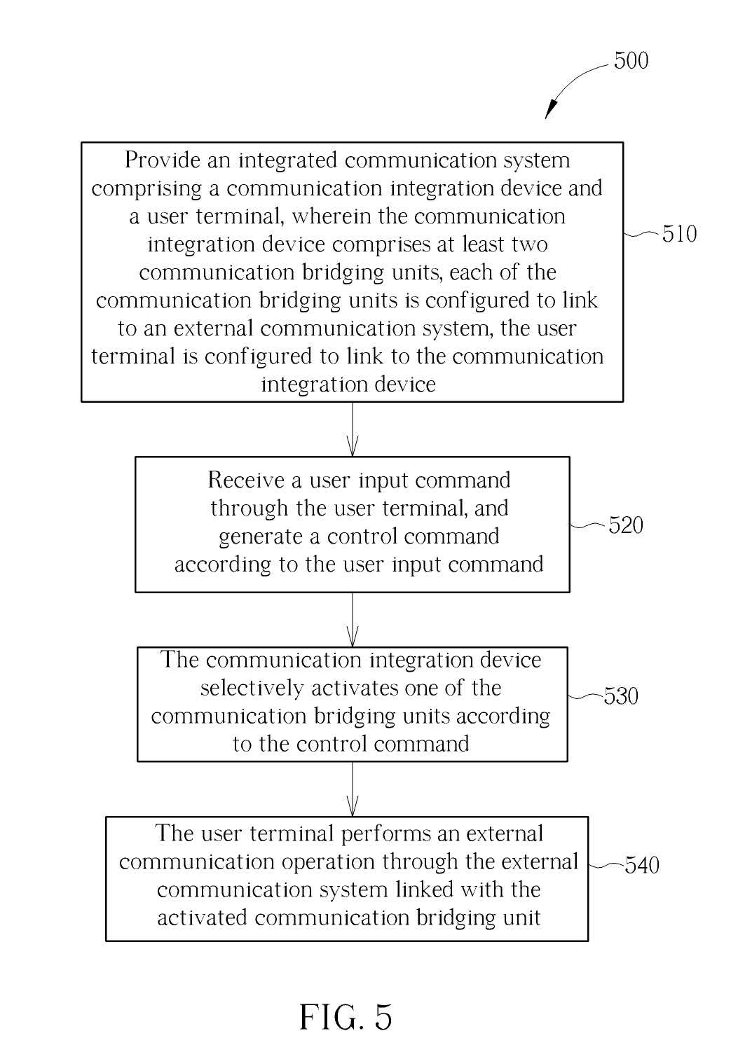

Please refer to FIG. 5. FIG. 5 is a flowchart 500 showing the method for integrating communication of the present invention. The flowchart of the method for integrating communication of the present invention comprises the following steps:

Step 510: Provide an integrated communication system comprising a communication integration device and a user terminal, wherein the communication integration device comprises at least two communication bridging units, each of the communication bridging units is configured to link to an external communication system, the user terminal is configured to link to the communication integration device;

Step 520: Receive a user input command through the user terminal, and generate a control command according to the user input command;

Step 530: The communication integration device selectively activates one of the communication bridging units according to the control command; and

Step 540: The user terminal performs an external communication operation through the external communication system linked with the activated communication bridging unit.

Basically, to achieve the same result, the steps of the flowchart 500 need not be in the exact order shown and need not be contiguous, that is, other steps can be intermediate.

In contrast to the prior art, the integrated communication system of the present invention can collect data from different external communication systems, then select to integrate with one of the external communication systems through operations of the user terminal, and further integrate communication function of the selected external communication system to the integrated communication system of the present invention, such that the user only needs to operate the user terminal to make an external call or perform other communication operations through the public switched telephone network (PSTN), Ethernet, Wi-Fi or mobile communication system. In addition, the integrated communication system of the present invention can automatically select the optimum communication device and communication mode for performing communication operations according to the predetermined priority of communication conditions, in order to reduce communication charge or improve communication quality. Therefore, the integrated communication system of the present invention can increase convenience and improve communication efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated communication system, comprising:
a communication integration device, comprising at least two communication bridging units and a communication integration module, wherein each of the communication bridging units is configured to link to an external communication system, the communication integration module can selectively activate one of the communication bridging units, and thereby integrate and link to the external communication systems linked with the communication bridging units; and
a user terminal, comprising a user interface and an internal communication unit, wherein the user interface can generate a control command according to a user operation for controlling the communication integration module to select to activate one of the communication bridging units, the internal communication unit can link to the communication integration device for performing external communication through the external communication system linked with the activated communication bridging unit.

2. The integrated communication system of claim 1 further comprising a data integration module configured to collect data via the communication bridging units and transmit the data to the user terminal for displaying on the user interface.

3. The integrated communication system of claim 2, wherein the data comprises phone book data, social network data, Internet communication data and/or short message data.

4. The integrated communication system of claim 1 further comprising a sub station, the sub station comprising a sub internal communication unit configured to communicate with the communication integration device, and perform an external communication operation through the external communication system linked with the activated communication bridging unit.

5. The integrated communication system of claim 1 further comprising a sub station, the sub station comprising:
an external device connection port, configured to couple with at least one external device, and link to an external communication system of the external device; and
a sub internal communication unit, configured to communicate with the communication integration device, and perform an external communication operation through the external communication system linked with the activated communication bridging unit.

6. The integrated communication system of claim 1, wherein the user interface is a touch display.

7. The integrated communication system of claim 1, wherein the external communication system comprises a public switched telephone network (PSTN), Ethernet, Wi-Fi or mobile communication system.

8. The integrated communication system of claim 1, wherein the internal communication unit is linked to the communication integration device via digital enhanced cordless telecommunication (DECT), Wi-Fi, Bluetooth, Zigbee, infrared, universal serial bus (USB) or Ethernet.

9. A method for integrating communication, comprising:
providing an integrated communication system comprising a communication integration device and a user terminal, the communication integration device comprising at least two communication bridging units, each of the communication bridging units being configured to link to an external communication system, the user terminal being configured to link to the communication integration device;
receiving a user input command through the user terminal, and generating a control command according to the user input command;
the communication integration device selectively activating one of the communication bridging units according to the control command; and
the user terminal performing an external communication operation through the external communication system linked with the activated communication bridging unit.

10. The method of claim 9 further comprising receiving data through the communication integration device and transmitting the data to the user interface.

11. The method of claim 10, wherein the data comprises phone book data, social network data, Internet communication data and/or short message data.

12. The method of claim 9, wherein the external communication system comprises a public switched telephone network (PSTN), Ethernet, Wi-Fi or mobile communication system.

13. The method of claim 9, wherein the user terminal is configured to link to the communication integration device via digital enhanced cordless telecommunication (DECT), Wi-Fi, Bluetooth, Zigbee, infrared, universal serial bus (USB) or Ethernet.
